(19) United States
(12) Patent Application Publication
(10) Pub. No.: US 2006/0184388 A1
(43) Pub. Date: Aug. 17, 2006

(54) Consumers-buyers-physicians health-care

(76) Inventor: Anuthep Benja-Athon, New York, NY (US)

Correspondence Address: ANUTHEP BENJA-ATHON, M.D.;Pain Management, Acupuncture Physical Therapy, 210 E 36th St., New York, NY, 10016, US

(21) Appl. No.: 11/059,088

(22) Filed: Feb. 16, 2005

(51) Int. Cl. G06Q 10/00; G10L 21/00

(52) U.S. Cl. 705/2; 704/212

(57) ABSTRACT

A system and method of controlling the expenses of health-care resources by companies, corporations, health-care consumers and physicians. The data on health-care consumers and resources being generated or expended by the above parties are available to, accounted for by and communicated among the above responsible parties in a check-and-balance health-care system accorded by a network or networks of computers.

### FIELD OF INVENTION

Health-care of and by the health-care consumers, buyers and physicians

### BACKGROUND OF THE INVENTION

A pending application filed Dec. 20, 2004 entitled the Physicians' Way of Information Productions bearing docket number ABA1220, a pending application Ser. No. 10/950,315 entitled a Method of Empowering Consumers-Controlled Health-Care filed Sep. 27, 2004, a pending application Ser. No. 10/760,694 entitled a method of Modulating Health-Care expenses filed Jan. 21, 2004, a pending application Ser. No. 10/328,993 entitled the Best American Healthcare System filed Dec. 26, 2002, and an abandoned application Ser. No. 10/298,100 entitled the Best Healthcare System filed Nov. 18, 2002 and U.S. Pat. No. 6,132,218 entitled Images for Communication of Medical Information in Computer was granted to this applicant on Oct. 17, 2000 represent our continual quests to solve the current health-care crisis.

Today, a representation of the ongoing and lack of solution to the current health-care crisis—a national crisis—is well represented in a Feb. 8, 2005 national publication wherein it recorded the perpetually escalating health-care costs, expenses, liability and frustration of a major Detroit car manufacturer. This escalation and frustration continues and are projected to grow bigger despite all efforts including the cut-backs such as the reductions of physicians' reimbursements and membership by its affiliated insurance. The consequences are obvious.

In summary, any and all attempts and efforts by all parties in the current prior art health-care system have failed to heretofore curb the escalating health-care costs and improve the quality of health-care of Americans. There are more uninsured Americans than ever.

In other words, the solution for curbing the rising health-care costs and expenses was not heretofore found. Neither the current nor prior art health-care systems and policies lack the ability or means for solving the current health-care crisis. Consequently, the adverse health and economic consequences affecting this nation are obvious.

The solution to the above problems is herein provided by the present invention which described a check-and-balance health-care system being formed by and for health-care consumers and buyers and physicians which did not exist and cannot come into existence under the means and methods of prior art health-care system.

This patent application is a check-and-balance system involving health-care consumers and buyers and physicians. It is the effective means for effectively curbing and reducing the escalating health-care costs and improving people's health, quality of life and standard of living.

### SUMMARY OF THE INVENTION

Any and all attempts by all parties in the current prior art health-care system have failed to heretofore solve the current health-care crisis.

The present invention provides a system and method of controlling the expenses of health-care resources by companies, corporations, health-care consumers and physicians. The data on health-care consumers and resources being generated or expended by the above parties are available to, accounted for by and communicated among the above responsible parties in a check-and-balance health-care system accorded by a network or networks of computers. The check-and-balance health-care system wherein health-care consumers and buyers and physicians interact productively and resourcefully in all aspects of health-care without the wastes generated by and interferences of non-essential parties.

### DESCRIPTION OF THE PREFERRED EMBODIMENTS

The present invention provides a system and method of controlling health-care costs of companies, corporations and health-care consumers—all of whom are the buyers of health-care—by said companies, corporations, health-care consumers and physicians. In other words, said buyers and physicians are two and only parties exerting full and independent control—a check-and-balance system—on the utilizations and dispensations of health-care resources.

The present invention provides that said buyers set up, administer and own individual health-care-related accounts. Said buyers are recognized and identified by a plurality of physicians or a network of physicians who accept the payments for health-care services and the like by said health-care buyers;

The system also provides said physicians the use of digital voice recorders and conversions of voice data comprising medical information on said consumers into digital data adaptable to be used in a computer or a plurality of computers and securely transmitting by a network or a plurality of networks of computers. Said physicians and consumers can inspect and share said digital data and related outcomes.

Moreover, said digital data and related outcomes are related to individual monetary values so that said physicians are paid for their services and the like rendered to said consumers. A plurality of computers, a network of computers or a plurality of networks of computers are used to account, debit and credit from health-care buyers' accounts and physicians' accounts. Similarly, a plurality of computers, a network of computers or a plurality of networks of computers are used to share data on said debits and credits among said buyers and physicians.

The present invention's said network or networks of computers can be had by using various commercially available computer networking gears such as those made by Cisco System. For example, the Virtual Private Network (VPN) including all accessories means and softwares and the like is one of the means for networking computers according to the claims.

Although the preferred embodiments have been described, it will be appreciated by those skilled in art that variations, adaptations and applications of the present invention can be had without departing from the spirit of the invention and the scope of the claims.

1. A system of controlling health-care costs of companies, corporations and health-care consumers collectively known as health-care buyers by companies, corporations, health-care consumers and physicians comprises:
individual health-care-related accounts of individual health-care buyers;
the administrations of individual health-care-related accounts by individual health-care buyers;
a plurality of physicians recognizing individual health-care buyers;
a plurality of physicians identifying individual health-care buyers;
a plurality of physicians accepting health-care buyers' payments;
the recognitions of a plurality of health-care consumers relating to individual companies or corporations;
the uses of digital voice recorders by physicians;
the conversions of physicians' voice data into digital data;
the inspections of digital data by physicians;
the inspections of digital data by health-care consumers;
a means for networking computers;
a computer networking means for transmitting said digital data;
a computer networking means for sharing said data;
a computer networking means for sharing the outcomes of said data;
said digital data relating to individual electronic payments;
said outcomes relating to individual electronic payments;
the linking of individual debits from said accounts to said digital data;
the linking of individual debits from said accounts to said outcomes;
the electronic disbursements of said accounts by health-care buyers;
the electronic debiting of payments from said accounts;
the accounting of payments from said accounts by health-care buyers;
a computer networking means for debiting from said health-care-related accounts;
a computer networking means for crediting said physicians' accounts;
the electronic transactions of individual debits from said accounts to credit individual physicians' accounts; and
a computer networking means for sharing data on said debits and credits.

2. A system of converting physicians' speeches containing data on health-care consumers into digital data for reducing health-care costs of companies, corporations and health-care consumers collectively known as health-care buyers by companies, corporations, health-care consumers and physicians comprises:
individual health-care-related accounts of individual health-care buyers;
a process of administering individual health-care-related accounts by individual health-care buyers;
a plurality of physicians recognizing individual health-care buyers;
a plurality of physicians identifying individual health-care buyers;
a plurality of physicians accepting health-care buyers' payments;
a process of recognizing a plurality of health-care consumers relating to individual companies or corporations;
a process of using digital voice recorders by physicians;
a process of converting physicians' voice data into digital data;
a process of the inspecting digital data by physicians;
a process of inspecting digital data by health-care consumers;
a means for networking computers;
a computer networking means for transmitting said digital data;
a computer networking means for sharing said data;
a computer networking means for sharing the outcomes of said data;
a process of relating digital data to individual electronic payments;
a process of relating said outcomes to individual electronic payments;
a process of linking individual debits from said accounts to said digital data;
a process of linking individual debits from said accounts to said outcomes;
a process of electronic disbursing of said accounts by health-care buyers;
a process of electronic debiting of payments from said accounts;
a process of accounting of payments from said health-care-related accounts by health-care buyers;
a computer networking means for debiting said health-care-related accounts;
a computer networking means for crediting physicians' accounts;
a process of electronically transacting individual debits from said health-care-related accounts to credit individual physicians' accounts; and
a computer networking means for sharing data on debits and credits.

3. A method of converting physicians' speeches containing data on health-care consumers into digital data for reducing health-care costs of companies, corporations and health-care consumers collectively known as health-care buyers by companies, corporations, health-care consumers and physicians in the consumers-buyers-physicians-directed health-care system comprises:
individual health-care-related accounts of individual health-care buyers;
a process of administering individual health-care-related accounts by individual health-care buyers;
a plurality of physicians recognizing individual health-care buyers;
a plurality of physicians identifying individual health-care buyers;
a plurality of physicians accepting health-care buyers' payments;
a process of recognizing a plurality of health-care consumers relating to individual companies or corporations;
a process of using digital voice recorders by physicians;
a process of converting physicians' voice data into digital data;
a process of the inspecting digital data by physicians;
a process of inspecting digital data by health-care consumers;
a means for networking computers;
a computer networking means for transmitting said digital data;
a computer networking means for sharing said data;
a computer networking means for sharing the outcomes of said data;
a process of relating digital data to individual electronic payments;
a process of relating said outcomes to individual electronic payments;
a process of linking individual debits from said accounts to said digital data;
a process of linking individual debits from said accounts to said outcomes;
a process of electronic disbursing of said accounts by health-care buyers;
a process of electronic debiting of payments from said accounts;
a process of accounting of payments from said health-care-related accounts by health-care buyers;
a computer networking means for debiting said health-care-related accounts;
a computer networking means for crediting physicians' accounts;
a process of electronically transacting individual debits from said health-care-related accounts to credit individual physicians' accounts; and
a computer networking means for sharing data on debits and credits.
